(19) United States
(12) Patent Application Publication
(10) Pub. No.: US 2020/0258025 A1
(43) Pub. Date: Aug. 13, 2020

(54) MATCHING A REQUEST FROM A USER TO A SET OF DIFFERENT USERS FOR RESPONDING TO THE REQUEST

(71) Applicant: Thumbtack, Inc., San Francisco, CA (US)

(72) Inventors: Denys Kopiychenko, Pleasanton, CA (US); Muxing Chen, San Francisco, CA (US); Scott Zuccarino, San Francisco, CA (US); Benjamin Robert Anderson, San Francisco, CA (US); Harsh Pankaj Panchal, San Francisco, CA (US); Vikram Reddy Kadi, Walnut Creek, CA (US)

(21) Appl. No.: 15/929,223

(22) Filed: Feb. 12, 2020

Related U.S. Application Data
(60) Provisional application No. 62/805,237, filed on Feb. 13, 2019.

(51) Int. Cl. G06Q 10/06; G06F 16/248; G06F 16/2457

(52) U.S. Cl. CPC G06Q 10/063112; G06F 16/24575; G06F 16/248

(57) ABSTRACT

A server automatically generates a response to a request received from a first user. Configuration information is received from second users. A request is received from the first user. A first stage of matching the parameters of the request to the second users is performed. If the number of matching users is below a threshold, the first stage of matching is performed again expanding or loosening the requirements of the request. A second stage of matching is performed that includes computing a score, and second user(s) are selected based in part on the computed score.

### CROSS-REFERENCE TO RELATED APPLICATIONS

This application claims the benefit of U.S. Provisional Application No. 62/805,237, filed Feb. 13, 2019, which is hereby incorporated by reference.

### TECHNICAL FIELD

Embodiments of the invention relate to the field of data processing; and more specifically, to matching a request from a user to a set of one or more different users for responding to the request.

### BACKGROUND

Responses are commonly generated for responding to requests in data processing. Some responses are fully automatic and apply to all requests. For example, in the context of web servers, a request for a web page is typically responded with a response that contains the requested web page (if such a web page exists). This response is typically not customized to the individual requester.

Other types of responses are manually generated by the responder. For example, websites exist that allow potential service buyers to submit a request for a service that includes certain details of the request such as a category and a location, and the online marketplace may transmit the request to one or more service professionals that match the requested category and location, and the service professional may compose and generate a response. These responses are largely manual and can be time intensive.

Websites exist that allow potential service buyers to search for a service professional and/or to be matched with a service professional. By way of example, the potential service buyer may post a request for a service that includes certain details of the request such as a category and a location, and the online marketplace may transmit the request to all of the service professionals that match the requested category and location. However, transmitting the request to all of the service professionals (or many service professionals) does not scale with many requests and many service professionals using the online marketplace. For instance, a particular service professional may become inundated with requests, and/or many service professionals may respond to the potential buyer. Instead of transmitting the request to all of the service professionals that match the requested category and location, a simple limiting system may be used such that if the service professional did not use marketplace over a certain period of time, they would not be sent requests or would be sent a limited number of requests. However, this type of simple limiting system may have unintended consequences. For instance, if a service professional went on vacation, they may come back and find that the marketplace was not sending them requests. Also, in sending limited requests, service professionals may not be receiving the requests that they were interested in, which may cause them to stop using the online marketplace.

### SUMMARY

A server automatically generates a response to a request received from a first user. Response configuration information is received from each of a first plurality of second users, where the received response configuration information includes for each of the first plurality of second users: information indicating a type of request in which that second user is willing to fulfill including a set of one or more preferences for the type of request, and a number of requests that second user can fulfill in a given period of time. A request is received at the server from the first user, where the request includes a plurality of parameters including: a location where the request is to be fulfilled, a request type, and a set of one or more other parameters of the request type. A first stage of matching is performed that includes comparing the plurality of parameters of the request with the set of preferences received from the first plurality of second users to determine a number of the first plurality of second users whose set of preferences match. The server determines, as a result of the first stage of matching, that the number of the first plurality of second users whose set of preferences match is below a threshold, and responsive to this determination, expands the location where the request is to be fulfilled. The first stage of matching that includes comparing the plurality of parameters of the request but with the expanded location with the set of preferences received from the first plurality of second users to determine an updated number of the first plurality of second users whose set of preferences match. The server determines, as a result of the first stage of matching using the expanded location, that the updated number of the first plurality of second users whose set of preferences match meets the threshold. A second stage of matching is performed that includes computing a score for each of the updated number of the first plurality of second users. A capacity to fulfill the request of each of the updated number of the first plurality of second users is determined. The server selects a second plurality of second users based at least in part on the computed score and the determined capacity of each of the updated number of the first plurality of second users, where the second plurality of second users is less than the first plurality of second users. The server transmits a result to the first user that includes information identifying the selected second plurality of second users.

### BRIEF DESCRIPTION OF THE DRAWINGS

The invention may best be understood by referring to the following description and accompanying drawings that are used to illustrate embodiments of the invention. In the drawings:

FIG. 1 is a block diagram that illustrates an exemplary architecture for an improved system for matching a request from a user to a set of one or more different users for responding to the request, according to an embodiment;

FIG. 2 is a flow diagram that illustrates exemplary operations for matching a request from a user to a set of one or more different users for responding to the request according to an embodiment;

FIG. 3 is a block diagram that illustrates an embodiment of the selection limiter of FIG. 1 using a machine-learning model according to an embodiment;

FIG. 4 is flow diagram that illustrates exemplary operations for selecting a second group of responders according to an embodiment; and

FIG. 5 is a block diagram illustrating an exemplary data processing system that may be used in some embodiments.

### DETAILED DESCRIPTION

In an embodiment, a method and apparatus for an improved system for matching a request from a user (sometimes referred herein as a “requester”) to a set of one or more different users (sometimes referred herein as “responders”) for responding to the request is described. In a specific example, the request is for a service and data from the request is used to match the request to identified responders that may be suitable for fulfilling the service request. The data in the request includes data that is structured and may be received by the system through input of a form submitted by the requester. In an embodiment, multiple levels of matching are performed where a first level of matching retrieves a set of candidate responders and a second level of matching is performed on the set of candidate responders to select the matching responders. The first level of matching may be performed based on a set of course features based on the first set of data (e.g., based on data directly included in the first set of data and/or derived from the first set of data), and the candidate responders are those that match these features. The second level of matching may include computing a score for each candidate responder based on a scoring function and feature data. Based on the computed score, the matching responders(s) are determined.

In a specific example where the request is a service request, detailed information about the requested service is received by the system, such as through submission of a request form. Such a request form may be customized according to the category of service requested. The submission of the request form may provide a relatively large set of structured data that is used when matching with responders. For instance, the request includes a set of one or more request parameters that provide information about the request including the location in which the request is to be fulfilled and the category of the request. The request parameters may be different depending on the category of the request. For instance, if the request is for an Interior Design service, the request may specify a request parameter for what room(s) (e.g., kitchen, living room, bedroom, dining room, commercial or office space, etc.) are desired to be improved. As another example, if the category is French Lessons, the request may specify the age (or age range) of the person that wants to improve or learn French.

The responders provide response configuration information such as biographical information (e.g., name, location, profile photo) and details about the requests that they can fulfill. The details about the requests that a responder can fulfill is sometimes referred herein as responder preferences. The responder preferences may include the type of service they provide, travel preferences (whether they travel to fulfill the request), service description, price charged for the service, availability, and/or number of requests they can fulfill in a period of time. The system uses the response preferences when matching requests with potential responders.

The responder(s) that are selected may be selected from many more responders. In an embodiment, the selected responder(s) are selected based on multiple level matching where the first level of matching may be performed based on a set of course features including one or more of the request parameters and one or more response preferences. For instance, the category and location of the request may be matched with the category and location of the response preferences of the responders. The responder(s) that match these features are referred to as candidate responders. A second level of matching may include computing a score for each candidate responder based on a scoring function and feature data, to determine which responder(s) to select. The selection may be based on machine learning models with heuristics. For instance, in an embodiment, the score for each responder is calculated using one or more signals derived from data of the system including: the number of reviews of the responder; the average review rating of the responder; non-review related profile features (e.g., whether the responder has a profile picture); whether the responder has configured automatic response; the relative price the responder charges for fulfilling the request against other responders; the responsiveness of the responder to previous requests; the capacity of the responder to fulfill the request; the historical rate in which details of the responder are viewed by requesters; and/or the historical rate in which the responder is contacted by requesters. For instance, in an embodiment, the decision of selecting responder(s) may be based on one or more of the following: a relevance of the responder's response to the requester, maximizing fulfillment of requests, maximizing an overall aggregate measure of relevance across a plurality of requests, and predicted responsiveness of the responder.

In an embodiment, a request parameter may be a hard constraint that must be met to be a match or may be a preference that may match even if not exactly the same. For instance, if the request is for a wedding officiant that speaks Spanish, the language request parameter may be considered a hard constraint. In this example, a wedding officiant that does not speak Spanish will not be selected. As an example of a preference, if the request is for a housecleaner to clean a two-bedroom house, potentially responders that prefer to clean 3 or more bedroom houses may still be selected in certain circumstances. Determining whether a request parameter is a hard constraint or a preference may be done through an empirical analysis and the result is stored in the system.

After selecting the responder(s) for the request, the system provides results to the requester. In an embodiment, the result includes a response to the request that is automatically generated on behalf of a matching responder. This response is sometimes referred herein as an automatic response. The automatic response is sent to the requester. The automatic response may be sent to the requester automatically or as a result of the responder approving the response. The automatic response may be sent via email, text message, and/or a notification for a native application installed on a device of the requester.

In an embodiment, instead of or in addition to sending an automatic response, the result includes a customized web page that is automatically generated that includes information on the matching responders that is displayed to the requester. The information may include a profile link for each of the matching responders. The link may lead to a web page that allows the requester to view the profile, contact the responder, and determine availability of the responder. This customized web page may be referred herein as a landing page.

It is possible that there may be no or few matching responders resulting from the first level of matching and/or second level of matching. For instance, certain geographies and/or markets may not have many or any responders for fulfilling requests. In an embodiment, if the number of matching responders in the first level of matching is below a threshold, an expanded first level of matching is performed to expand the number of responder(s) that match the request. By way of example, the location may be expanded where the responders that are nearby the requested location will match the expanded first level of matching. As another example, the category may be expanded to a category that is related to the requested category. As another example, the request parameters may be expanded so that potential responders that may previously had a conflicting preference may match. As another example, the budget constraints may be eliminated or reduced such that a responder that would have otherwise matched can be selected.

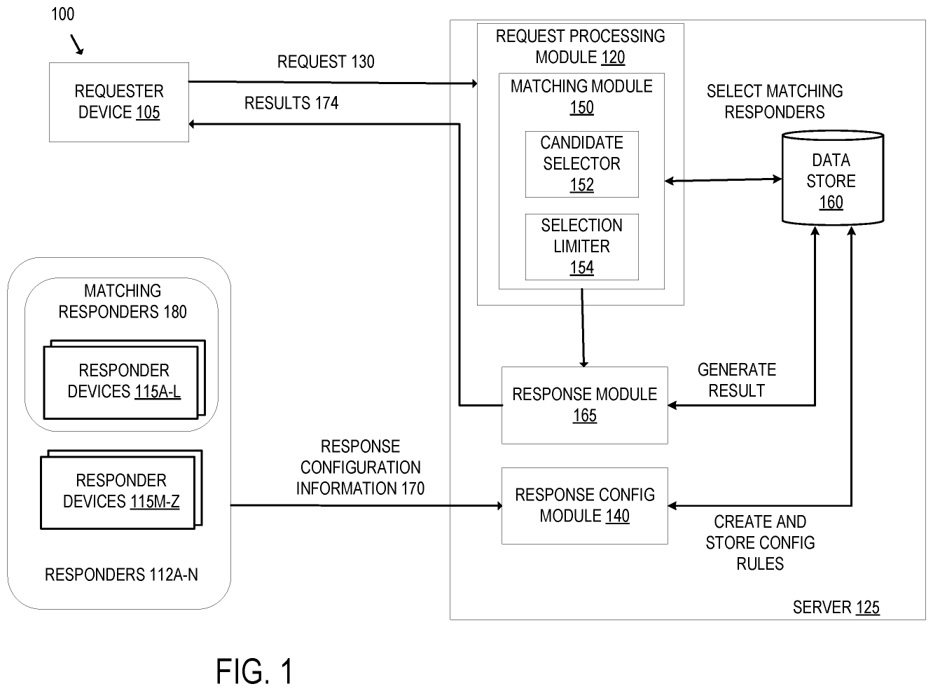

FIG. 1 is a block diagram that illustrates an exemplary architecture for an improved system for matching a request from a user to a set of one or more different users for responding to the request, according to an embodiment. The system 100 illustrated in FIG. 1 includes the requester device 105, the responder devices 115A-Z, and the server 125. The requester device 105 is operated by a requester and the responder devices 115A-Z are each operated by a different responder of the responders 112A-N. The requester device 105 and the responder devices 115A-Z each are types of computing devices that interact with the server 125 and may be a desktop, laptop, smartphone, tablet, wearable device, etc., that executes a client network application. The client network application may be a web browser (e.g., a desktop browser, a mobile optimized browser), a native application, or other application that can access network resources such as web pages, images, videos, or other computer files. The requester device 105 and the responder devices 115A-Z interact with the server 125 over a network, such as the internet.

The server 125 is a computing device that provides functionality for the improved system for matching requester requests with responders. In the embodiment illustrated in FIG. 1, the server 125 includes the request processing module 120, the response configuration module 140, the response module 165, and the data store 160. The data store 160 stores data related to the responders and the requesters and is used by the server 125 (e.g., the request processing module 120, the response configuration module 140, and/or the response module 165).

The data store 160 stores data related to the responders and the requesters. Although illustrated in FIG. 1 as part of the server 125, the data store 160 may be in a separate computing device than the server 125 and queried by the server 125. The data store 160 is used by the server 125 (e.g., the request processing module 120, the response configuration module 140, and/or the response module 165 when matching a request with one or more responders to respond to the request.

For each responder, the data store 160 may store responder profile information of the responder (typically provided by the responder), and statistical information of the responder (typically derived or calculated by the server 125). The responder profile information may include, for each responder, one or more of the following: the responder's name, the category (or categories) offered by that responder, the location where the service is offered, whether the responder travels to provide the service, contact information of the responder (e.g., email address, phone number, street address) pictures of the responder and/or service, videos of the responder and/or service, service description, whether the responder has passed a background check, and whether the responder has shown proof of being licensed, etc. The statistical information of the responder may include one or more of the following: the number of times the responder has been selected to fulfill a similar request, the number of responses sent by, or on behalf, of that responder, the number of times the responder has been selected for responding to requests, the request fulfillment rate of the responder (the number of times the responder has been selected to fulfill requests over the number of responses), the number of requests fulfilled by the responder in all categories, the rate at which the responder responds to a message from a requester, review(s) of the responder (typically provided by past requesters), and a rating of the responder based on the review(s).

For each requester, the data store 160 may store profile information of the requester (typically provided by the requester) and/or statistical information of the requester (typically derived or calculated by the server 125). The requester profile information may include, for each requester, one or more of the following: the name of the requester, the location of the requester, and contact information of the requester (e.g., email address, phone number, street address). The statistical information of each requester may include one or more of the following: request fulfillment rate of the requester in the requested category (hires over requests), request fulfillment rate of the requester in all categories (hires over requests), and the rate at which the requester responds to a responder, review(s) of the requester (typically provided by past responders).

The response configuration module 140 is adapted to be used by the responders for configuring automatic responses for responding to a request. The response configuration module 140 may provide an interface (e.g., available as a website or part of a native application) that allows responders to configure and manage (e.g., create, view, edit, delete, modify) rules for the automatic generation of responses to requests. The server 125 receives response configuration information 170 from each of the responders 112A-N, via the response configuration module 140. The response configuration information of a particular responder indicates the type of requesters they are willing to respond to, and/or the type of requests that they are willing to fulfill. The response configuration information from a responder may also include information for automatic generation of the response including their name, type of service they provide, location, travel preferences, profile photo, service description, service preferences, scheduling information (availability), capacity, and/or other basic information. The response configuration information may include information about the price the responder will charge for the service. The response configuration information may include information regarding the number of requests the responder can fulfill in a given period of time. The response configuration information may be stored in the data store 160.

The request processing module 120 is configured to receive and process requests from requesters. Each request defines the parameters of what is being requested. In a specific embodiment where the request is a request for service, the request defines the type of service requested, the location where the service is desired, a category of the desired service, and one or more request parameters.

The request processing module 120 selects the responder(s) that are eligible for responding to the request. In an embodiment, the request processing module 120 selects, from multiple responders, a set of one or more responders for responding to the request as a result of a matching process performed by the matching module 150. In the example shown in FIG. 1, the responders 180 that operate the responder devices 115A-L have been selected for automatic response to the request. In the embodiment shown in FIG. 1, the matching module 150 includes the candidate selector 152 and the selection limiter 154. The candidate selector 152 performs a first level of matching based on a set of one or more course features including matching one or more of the request parameters with one or more response preferences. For instance, the first level of matching may include matching the requested category and/or requested location against the response preferences stored in the data store 160. The responder(s) that match the first level of matching are the candidate responder(s). For instance, in the case where the request is a request for service and the request includes a requested location and category, the candidate selector 152 determines a set of one or more responders for responding to the request to be those that match the requested location and category. The candidate selector 152 accesses information about the responders such as the location(s) that they offer service and the category(ies) of service that they offer, from the data store 160. The candidate selector 152 compares the requested location and category with the information from the data store 160 to select the candidate responders. In a specific example, the first level of matching includes determining the responders that have the same zip code as the requested location and/or within a predefined number of miles/kilometers from the requested location and offer service in the same category as the request category. Although location and category may be matched, there may be other request parameters that are used to match against the response preferences. The identification of these other request parameters that are used to match against the response preferences may be determined through an empirical analysis and stored in the data store 160. There may be many responders that match based on the first level of matching. But, there may also be few responders that match based on the first level of matching.

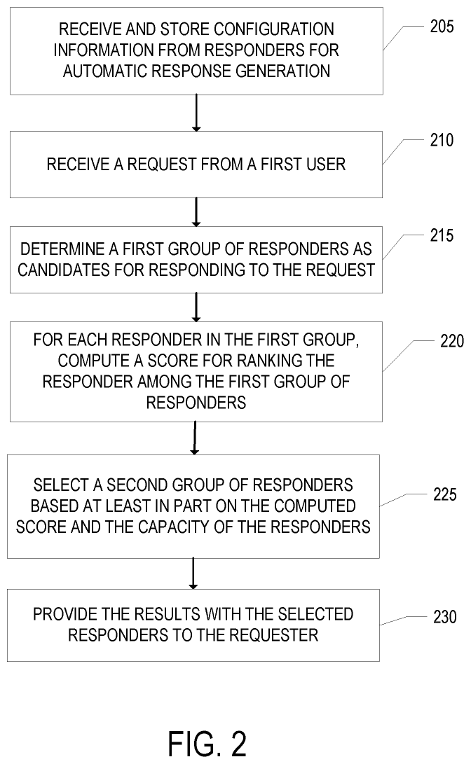

After the first level of matching is performed, the selection limiter 154 of the matching module 150 performs a second level of matching to refine which of the responder(s) that matched the first level of matching will be selected, assuming that there are many responders that match based on the first level of matching (e.g., the number of matching responders is greater than a predefined threshold). The selection limiter 154 may perform the second level of matching. In an embodiment, the second level of matching includes computing a score for each candidate responder based on a scoring function and feature data and using the resulting score to determine which responder(s) to select. The selection may be based on machine learning models with heuristics. For instance, in an embodiment, the score for each responder is calculated using one or more signals derived from data of the system including: the number of reviews of the responder; the average review rating of the responder; non-review related profile features (e.g., whether the responder has a profile picture); whether the responder has configured automatic response; the relative price the responder charges for fulfilling the request against other responders; the responsiveness of the responder to previous requests; the capacity of the responder to fulfill the request; the historical rate in which details of the responder are viewed by requesters; and/or the historical rate in which the responder is contacted by requesters. The second level of matching will be described in greater detail with respect to FIG. 2.

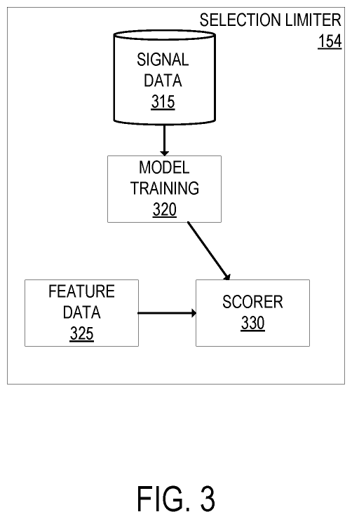

FIG. 3 is a block diagram that illustrates an embodiment of the selection limiter 154 using a machine-learning model, according to an embodiment. The model training module 320 takes as input a set of signal data stored in the signal data store 315 and outputs a model (a scoring function) that is used by the scorer 330. The signal data 315 is created from the requests and/or other interactions with the system such as historical information from the responders. The signal data 315 may be a subset of the data store 160 and/or may be derived from data of the data store 160. The signals used by the model training module 320 depends on the model that is being trained. Example signals for different models are described later herein. The scorer 330 calculates a score based on the feature data 325. The feature data 325 is a subset of the data store 160 and may include features derived from the request and/or historical behavior of the responders, and depends on the type of model being used.

It is possible that there may be no or few matching responders resulting from the first level of matching and/or second level of matching. For instance, certain geographies and/or markets may not have many or any responders for fulfilling requests. In an embodiment, if the number of matching responders in the first level of matching is below a threshold, the candidate selector 152 performs an expanded first level of matching to expand the number of responder(s) that match the request. By way of example, the location may be expanded where the responders that are nearby the requested location will match the expanded first level of matching. As another example, the category may be expanded to a category that is related to the requested category. As another example, the request parameters may be expanded so that potential responders that may previously had a conflicting preference may match. As another example, the budget constraints may be eliminated or reduced such that a responder that would have otherwise matched can be selected.

The response module 165 is configured to automatically respond to the request 130 by providing the results 174 to the requester device 105. In an embodiment, the results include the response module 165 automatically generating a response on behalf of a selected responder based on the response configuration information received from the responders and/or the request. The response module 165 may automatically generate a response on behalf of each such selected responder. Additionally, or alternatively, the results include the response module 165 generating a landing page that includes information on the selected responders. The response module 165 is also configured to communicate the generated response(s) to the requesting device.

FIG. 2 is a flow diagram that illustrates exemplary operations for matching a request from a user to a set of one or more different users for responding to the request according to an embodiment. The operations of FIG. 2 will be described with respect to the exemplary embodiment of FIG. 1. However, the operations of FIG. 2 can be performed by different embodiments than those discussed with FIG. 1, and the exemplary embodiment of FIG. 1 can perform different embodiments than those discussed with respect to FIG. 2.

At operation 205, the response configuration module 140 receives and stores the configuration information 170 for configuring automatic response generation on behalf of a responder. The received configuration information 170 is used by the response configuration module 140 to configure rules for generating responses on behalf of the responder. For instance, in an embodiment where the response is generated in reply to a request for service, the configuration information 170 may specify one or more of: the type of requesters they are willing to respond to, and/or the type of requests that they are willing to fulfill. The response configuration information from a responder may also include information for automatic generation of the response including their name, type of service they provide, location, travel preferences, profile photo, service description, scheduling information (availability), and other basic information. The response configuration information may include information about the price the responder will charge for the service. The response configuration information may include information regarding the number of requests the responder can fulfill in a given period of time. The response configuration information may be stored in the data store 160.

At operation 210, the request processing module 120 of the server 125 receives a request 130 from a first user. The request may be a request for service and define parameters for the requested service. For instance, the request may specify a specify a location where the service is desired and a category of the desired service. Typically, the location indicates where the requester is located and/or how far the requester is willing to travel for the requested service. The location may be entered as a city, a street within a city, a zip code, etc. The category of service indicates the type of service that is desired. There may be many different categories that can be selected and/or input by the requester. As an example, French Lessons may be a category. As another example, Interior Design may be a category. The request may also include information about the requested service, dependent upon the category, that may be used by the system to match the requester with the responders. This information is sometimes referred herein as request preferences. For instance, if the category is Interior Design, the request may specify what room(s) (e.g., kitchen, living room, bedroom, dining room, commercial or office space, etc.) are desired to be improved, which can be used to match to responders that specialize in those rooms (some designers may specialize in kitchen remodels, for example). As another example, if the category is French Lessons, the request may specify the age (or age range) of the person that wants to improve or learn French that can be used to match to responders (some providers offering French Lessons may not be adapted to teach young children, for example).

In an embodiment, the request 130 specifies that the requester wishes to receive responses that have been automatically generated (as opposed to being manually generated). Thus, instead of having to wait to receive a response that is largely manually generated, the requester can receive responses much more quickly because they have been automatically generated. This leads to higher engagement rates of the requester since they can determine whether to act upon the response in a shorter time frame. This in turn leads to higher chances of a responder being selected to fulfill the request, and a faster process to get the request fulfilled.

The matching module 150 of the server 125 performs a first level of matching to determine a first group of responders as candidates for responding to the request. Thus, at operation 215, the candidate selector 152 of the matching module 150 determines a first group of responders as candidates for responding to the request. The first level of matching is based on matching a set of one or more course features including matching one or more of the request parameters with one or more response preferences. In a specific example where the request is for a service and includes a requested location and category, the matching module 150 determines the first group of responders to be those that match at least the requested location and category. The matching module 150 accesses information about the responders such as the location(s) that they offer service and the categor(ies) of service that they offer from the data store 160. The candidate selector 152 compares the requested location and category with the information from the data store 160 to select the candidate responders. Depending on the location and/or category, there may be many candidate responders. Flow moves from operation 215 to operation 220.

Although location and category may be matched, there may be other request parameters that are used to match against the response preferences. The identification of these other request parameters that are used to match against the response preferences may be determined through an empirical analysis and stored in the data store 160, and may differ depending on the category.

After determining the candidate responders, the matching module 150 of the server 125 performs a second level of matching to refine which responders are selected for automatic response generation. The second level of matching is intended to determine which set of responders are best suited for fulfilling the request, and may take the following factors into consideration: the requester's requirements included in the request, the responder's express intent and derived interest in fulfilling the request, the qualification of the responder for fulfilling the request, whether the responder is a good fit for the request (e.g., for request for services involving personal preferences or style, such as interior design jobs), whether the request is a good fit for the responder and is likely to deliver value to the responder's business, maximizing fulfillment of requests, maximizing an overall aggregate measure of relevance across a plurality of requests, and/or a predicted responsiveness of the responder. In a specific implementation, the second level of matching may include computing a score for each candidate responder based on a scoring function and feature data, to determine which responder(s) to select. The selection may be based on machine learning models with heuristics. For instance, in an embodiment, the score for each responder is calculated using one or more signals derived from data of the system including: the number of reviews of the responder; the average review rating of the responder; non-review related profile features (e.g., whether the responder has a profile picture); whether the responder has configured automatic response; the relative price the responder charges for fulfilling the request against other responders; the responsiveness of the responder to previous requests; the capacity of the responder to fulfill the request; the historical rate in which details of the responder are viewed by requesters; and/or the historical rate in which the responder is contacted by requesters.

At operation 220, the selection limiter 154 of the matching module computes a score for ranking the responder among the group of candidate responders. In an embodiment, the score is calculated using a machine learning model with heuristics such as a logistic regression model. In an embodiment, the score is calculated using one or more signals derived from data of the system including: the number of reviews of the responder; the average review rating of the responder; non-review related profile features (e.g., whether the responder has a profile picture); whether the responder has configured automatic response; the relative price the responder charges for fulfilling the request against other responders; the responsiveness of the responder to previous requests; the capacity of the responder to fulfill the request; the historical rate in which details of the responder are viewed by requesters; and/or the historical rate in which the responder is contacted by requesters.

Through an empirical data analysis, the number of reviews of a responder is correlated with the request fulfillment rate of the responder. Similarly, the rating of the reviews is also correlated with the request fulfillment rate of the responder. To say it another way, responders that have a relatively large number of reviews and are rated relatively high tend to be selected by requesters to fulfill requests at a higher rate than responders with a relatively low number of reviews and/or low rating. Moreover, the number of and rating of verified reviews (those that have been verified as coming from a requester that selected the responder) may correlate with the request fulfillment of the responder.

Non-review related profile features of the responder may be correlated with the request fulfillment rate of the responder, such as the existence of a profile picture, the number of profile pictures, the number of videos, profile completion status, the number of times the responder has been selected to fulfill a request, the length of the service description, whether the responder has passed a background check, and/or whether the responder shows proof of being licensed. For instance, responders with profile picture(s) may have a larger request fulfillment rate than those responders that do not have profile picture(s). Also, the number of pictures can have a correlation with request fulfillment rate. For instance, the request fulfillment rate of responders tends to go up until about 5 pictures where the request fulfillment rate levels off. The number of videos of a responder may be correlated with the request fulfillment rate of the responder depending on the category of service provided. Whether a responder has passed a background check may impact request fulfillment rate depending on the service category. For example, responders that have passed a background check may have a larger request fulfillment rate in service categories that concern children (e.g., babysitting, tutoring, music lessons, etc.). Responders that have evidence of being licensed may have a higher request fulfillment rate than other responders in certain categories (e.g., wellness, personal, pets).

The response time of a responder is correlated with the request fulfillment rate. For instance, how quickly the responder responds to messages or questions from a requester impacts the request fulfillment rate. That is, responders that respond more quickly have a higher request fulfillment rate than other responders. The response time may be weighed more heavily in recent time windows and/or only viewed in a certain time window. For instance, the average response time in the past year (or other predefined time period) may be used.

The previous request fulfillment rate is generally correlated with the current request fulfillment rate. That is, the request fulfillment rate of responders for a service category generally tends to stay roughly linear. The number of previous times a responder has been selected to fulfill a request over a given time period (e.g., over the last year) may be used.

The distance between the requested location and the responder may impact request fulfillment rate. For instance, request fulfillment rate for a responder generally goes down as distance increases. This value may be dependent on whether the requester travels to the responder for the requested service, whether the responder travels to the requester for the requested service, or whether the requested service is done remotely. In cases where the requester travels to the responder for the requested service, the request fulfillment rate may generally go down as distance increases. In cases where the responder travels to the requester for the requested service, the request fulfillment rate may generally go down as distance increases, but generally not as much as if the requester travelled to the responder. In cases where the requested service may be done remotely, the distance between the requested location and the responder may not impact the request fulfillment rate.

Information from the perspective response, such as the price to fulfill the request may also impact the request fulfillment rate. For instance, a responder that is offering a price to fulfill the request that is much higher or much lower than other responders in the same category may negatively impact the request fulfillment rate. A responder that is offering a lower price to fulfill the request than other responders in the same category will receive a higher boost compared to a responder that is offering a higher price. In an embodiment, the fulfillment offers are ranked by price and a boost score (e.g., between 0 and 1) is assigned evenly based on the prices. For instance, the higher the price the lower the boost score.

In another embodiment, the price boost score is computed in accordance with the following. The median price is determined. An intermediate price boost is calculated as the price of the responder divided by the median price. The intermediate price is capped between two predetermined values to handle outliers (e.g., a responder with a very low price as compared to other responders). For instance, the cap may be set between 0.4 and 2. The capped intermediate price boost is transformed using so that the higher the price the lower the score. For instance, the capped intermediate price boost may be transformed by subtracting it from a maximum score (e.g., 2). The price boost may then be scaled between two predetermined numbers (e.g., 0.6 and 1).

The capacity of the responder to fulfill the request may be calculated when determining if the responder is selected for automatic response generation. The total capacity may be provided by the responder and monitored by the matching module 150. For instance, the responder may specify how many requests they can fulfill over a period of time (e.g., per day, per week, per month, etc.) and the server may track how many requests the responder has fulfilled and/or agreed to fulfill over that period of time. In an embodiment, the responders are charged when an automatic response is placed on their behalf. In another embodiment, the responders are charged when a requester makes a contact (e.g., sends a message, places a phone call through the platform, etc.) in response to an automatic response being placed on their behalf. In such embodiments, instead of, or in addition to, specifying how many requests a responder can fulfill over a period of time, the responder may specify a response budget that indicates how many responses can be generated on their behalf. The response budget may be an overall budget or may be a recurring budget over a period of time (e.g., a response budget per day, per week, per month, etc.). In an embodiment, the number of responses generated on behalf of a responder over a given time period may be for more requests than that responder has current capacity to fulfill, if it is determined that the responder on average does not typically get selected for every response that is generated. The server tracks the response budget and determines whether the responder has capacity to fulfill the request. If the responder does not have capacity to fulfill the request, they may not be selected for automatic response generation of the present request.

The historical rate in which details of the responder are viewed by requesters may be used when calculating the score of the responder. For instance, the rate may be determined by dividing the number of detail views that the responder has received over a time period (e.g., 90 days) by the number of impressions of the responder over that time period. The number of impressions of the responder may be defined as the number of times a response has been automatically generated on behalf of that responder and transmitted to a requester.

The historical rate in which the responder is contacted by requesters may be used when calculating the score of the responder. For instance, this rate may be determined by dividing the number of contacts that the responder has received over a time period (e.g., 90 days) by the number of impressions of the responder over that time period.

As a specific example, a logistic regression machine learning model is used to compute the score in operation 220 using one or more of the following inputs: the average rating of the responder; the average response time (e.g., in minutes, in hours, etc.) of the responder over a given period of time (e.g., the last week, month, etc.); the presence of a profile picture of the responder; whether the responder has previously fulfilled a request of the requested category; whether the responder is rated as a top responder; the total number of reviews of the responder; the price boost score of the responder; whether the responder has configured automatic response; the average contact rate of the responder (e.g., the number of contacts the responder recieves from requesters divided by the number of responses presented to the responders), taken as a weighted moving average (the recent data having a higher weight than older data) over a period of time (e.g., the last 180 days); the number of licenses the responder has; the number of background checks completed for the responder; the number of pictures on the profile page of the responder; the number of videos on the profile page of the responder; the total number of requests fulfilled by the responder; and the total number of responses sent by or on behalf of the responder.

Next, at operation 225, the selection limiter 154 selects a second group of responders based at least in part on the computed score and the capacity of the responders. For instance, the selection limiter 154 may rank the responders that have capacity to fulfil the request by the score and select the second group of responders according to that ranking. As another example, the selection limiter 154 may distribute the responses across multiple requests and/or expected requests. For instance, the selection limiter 154 may select the members of the second group of responders to maximize the chances to fill all requester requests (existing and expected) over a given period of time (e.g., daily, weekly, monthly). For instance, consider a case where a market has two tutoring responders that can each fulfill one request for tutoring per week where the first responder can tutor math only and the second responder can tutor math and chemistry. If the math tutoring request is fulfilled by the second responder during the week, then there is no one in the market that can fulfill the chemistry request during that week. On the other hand, if the math tutoring request is fulfilled by the first responder during the week, then a chemistry request may be fulfilled by the second responder. As another example, the selection limiter 154 may select the members of the second group of responders to maximize the relevance of the responders' responses to requesters over a longer period of time by forecasting future requester needs and using the forecast to maximize an overall aggregate measure of relevance across many requests (e.g., all requests in a market over a week).

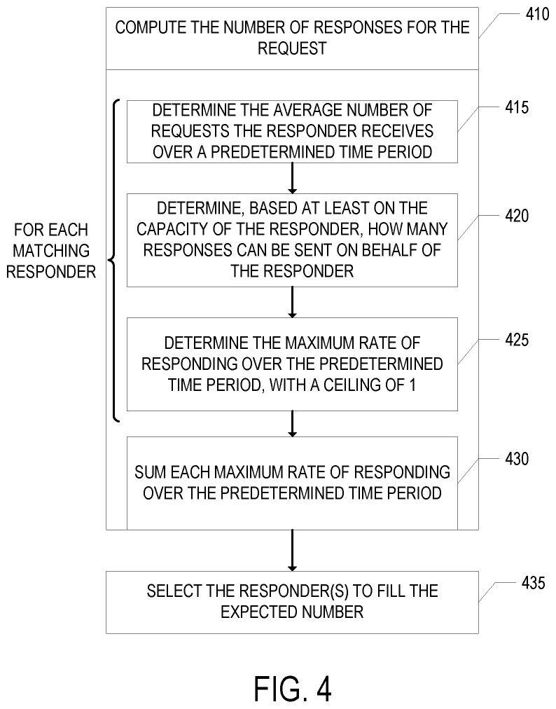

FIG. 4 is flow diagram that illustrates exemplary operations for selecting a second group of responders according to an embodiment. For instance, the operations of FIG. 4 may be performed during the operation 225. At operation 410, the selection limiter 154 computes the number of responses for the request. The number of responses for the request may be determined as a function of the number of responders that are eligible and have capacity for the requested service, the aggregate of the number of fulfillments over responses for the requested category (that is, the average of how many responses turn into fulfillments for the requested category), and the expected number of future requests for the requested category.

In an embodiment, computing the number of responses for the request includes performing operation 415-430. The operations 415-425 are performed for each responder that matched the first level of matching. At operation 415, the selection limiter 154 determines the average number of requests the responder receives or has been determined to match (e.g., after the second level of matching) in the requested category over a predetermined time period (e.g., per day, per week, per month, etc.). Next, at operation 420, the selection limiter 154 determines, based at least on the capacity of the responder, how many responses can be sent on behalf of the responder. As previously described, the number of responses sent on behalf of the responder over a given time period may be higher than the capacity of the responder over that time period. The selection limiter 154 may determine the average rate at which the responder gets selected to fulfill a request over the number of responses sent over the predetermined time period. The maximum number of responses may be set as the capacity of the responder divided by the average request fulfillment rate of the responder. For instance, if the capacity of the responder for a week is 5 fulfillments and the average request fulfillment rate of the responder is 0.5, the maximum number of responses that can be sent on behalf of the responder may be 10. Next, at operation 425, the selection limiter 154 determines the maximum rate of sending a response over the predetermined time period, with a ceiling of 1. For instance, the maximum rate of sending a response may be calculated as the maximum number of responses over the average number of requests the responder receives over the predetermined time period. For instance, if the responder receives 15 requests on average over the predetermined time period and the maximum number of responses over that time period is calculated to be 10, the maximum rate of sending a response over the time period may be 10/15. Next, at operation 430, the selection limiter 154 determines the sum of each maximum rate of sending a response for each responder as found in operation 425. The computed number of responses for the request is based on the sum of each maximum rate. For instance, the computed number of responses may be the sum of the maximum rates rounded down to the nearest integer. As an example, if the sum of the maximum rates is 3.8, the number of responses may be set as 3. As another example, if each responder had a maximum rate of sending a response as 1, the sum of each maximum rate of sending a response would be equal to the number of responders that matched the first level of matching.

In an embodiment, the selection limiter 154 may limit the number of responses to a predefined number (e.g., up to five responses), and/or reserve a number of responses for those responders that have recently registered with the system (e.g., within a predefined period of time such as 30 days) and/or have recently begun offering service for the requested category in the requested location (e.g., within the predefined period of time).

After computing the number of responses for the request, flow moves to operation 435 where the selection limiter 154 selects the responder(s) to fill the number of responses. The selection of the responders may be based on a ranking of the responders and may be randomized. For instance, the ranking of each responder may be the same as described in operation 1025, and may be weighed based on the maximum rate of sending a response over the predetermined time period found in operation 425 (e.g., the computed score that quantifies a likelihood of the requesting requester hiring that responder multiplied by the maximum rate of sending a response over the predetermined time period). The resulting scores for the responders may be ranked and the responses may be generated for the highest-ranking responders. A weighted random sampling may also be applied to produce randomness, such as according to the A-ES algorithm of Efraimidis and Spirakis.

After selecting the second group of responders in operation 225, flow moves to operation 230 where the response module 165 provides the results to the requester. In an embodiment, the results include one or more responses that were automatically generated on behalf of the selected second group of responders. These responses are generated from the response configuration information received from the respective responders. There may be a unique response generated on behalf of each of the selected second group of responders. In an embodiment, prior to transmitting the generated responses, the generated responses are provided to the responders for review. For instance, a message may be transmitted to the responder (e.g., email, text message, phone call, message within a native application) that indicates that there is a response pending their review. The responder may then adjust the generated response, cancel the response, or approve the response. In another embodiment, the generated responses are automatically sent to the requester on behalf of thee responders without the responders reviewing or otherwise approving the generated responses.

Alternatively, or in addition to generating a response on behalf of the selected second group of responders, the results may include a customized web page that includes information on the matching responders. The information may include for each responder a link to a profile to that responder.

In an embodiment, if the number of responders in the first group is lower than a threshold number and/or the number of responders in the second group with a ranking score that is below a threshold score, then the matching module 150 performs an expanded level of matching to expand the number of responder(s) that match the request.

In an embodiment, any one or more of the request parameters may be modified to increase the number of matching responders. For instance, the geographic parameter (e.g., the location specified in the request) may be expanded to include one or more nearby locations. For instance, if the requested location is a zip code, the expanded location may include a set of one or more zip codes that are within a predetermined radius of the requested zip code. As another example, if the requested location specifies a city, the expanded location may include a set of one or more cities that are within a predefined number of miles/kilometers from the requested location. The matching process described in FIG. 2 can then be performed using the expanded location.

As another example, in addition to or in lieu of expanding the location, the requested category may be expanded to include a set of one or more related categories to increase the number of matching responders. What is a related category may be determined based on a memory-based collaborative filtering algorithm and optionally tuned with manual boosts. In an embodiment, the memory-based collaborative filtering algorithm uses historical data to determine the extent to which responders historically submit a response for a set of one or more other categories in addition to the requested category. If, based on the historical data, the number or rate of responders submitting a response for the requested category and another category exceeds a threshold, then that another category is a related category, according to an embodiment. If there are multiple related categories, the related categories that are selected may have the most overlap of requests to the requested category. For manual boosts, the memory-based collaborative filtering algorithm may be manually adjusted based on empirical data analysis of what categories should be related. For instance, if the algorithm suggests a “Handyman” category is related to a “Play Equipment Construction” category, it might be excluded or demoted since it may not be reasonably related. The matching process described in FIG. 2 can then be performed using the related category.

As another example, in addition to or in lieu of expanding the location and/or category, one or more soft request parameters may be ignored or relaxed to increase the number of matching responders. For instance, the matching module 150 may access information about the request and determine if there are any soft request parameters and ignore or relax the soft parameters.

As another example, the budget constraints may be eliminated or reduced such that a responder that would have otherwise matched can be selected.

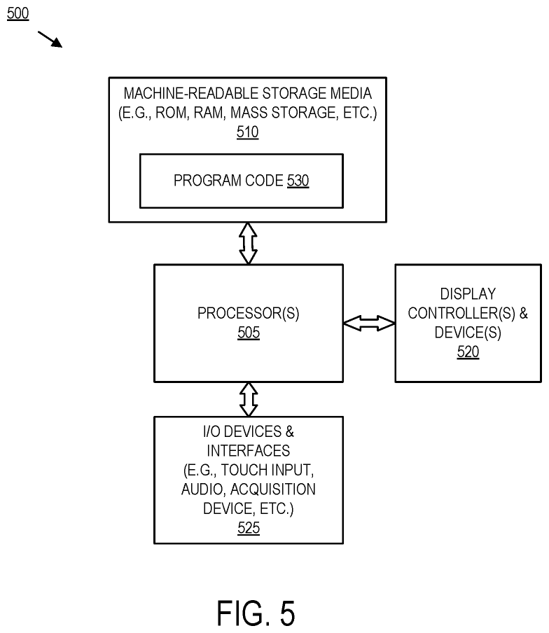

FIG. 5 illustrates a block diagram for an exemplary data processing system 500 that may be used in some embodiments. Data processing system 500 includes one or more processors 505 and connected system components (e.g., multiple connected chips). Alternatively, the data processing system 500 is a system on a chip or Field-Programmable gate array. One or more such data processing systems 500 may be utilized to implement the embodiments as illustrated in FIGS. 1-4.

The data processing system 500 is an electronic device which stores and transmits (internally and/or with other electronic devices over a network) code (which is composed of software instructions and which is sometimes referred to as computer program code or a computer program) and/or data using machine-readable media (also called computer-readable media), such as machine-readable storage media 510 (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals), which is coupled to the processor(s) 505. For example, the depicted machine-readable storage media 510 may store program code 530 that, when executed by the processor(s) 505, causes the data processing system 500 to enable matching a request from a first user to a set of one or more different users as described herein. For example, the program code 530 may include code for the request processing module 120 (including the matching module 150), response module 165, and the response configuration module 140, which when executed by the processor(s) 505, causes the data processing system 500 to perform the operations of the server 125 described with reference to FIGS. 1-4.

The data processing system 500 may also include a display controller and display device 520 to provide a visual user interface, e.g., GUI elements or windows. The visual user interface may be used to enable a requester to submit a request, a responder to review and/or respond to a request, or other task as described herein. The data processing system 500 also includes one or more input or output (“I/O”) devices and interfaces 525, which are provided to allow a user to provide input to, receive output from, and otherwise transfer data to and from the system. These I/O devices 525 may include a mouse, keypad, keyboard, a touch panel or a multi-touch input panel, camera, frame grabber, optical scanner, an audio input/output subsystem (which may include a microphone and/or a speaker for, for example, playing back music or other audio, receiving voice instructions to be executed by the processor(s) 505, playing audio notifications, etc.), other known I/O devices or a combination of such I/O devices. The I/O devices and interfaces 525 may also include a connector for a dock or a connector for a USB interface, FireWire, Thunderbolt, Ethernet, etc., to connect the system 500 with another device, external component, or a network. Exemplary I/O devices and interfaces 525 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 500 with another device, external component, or a network and receive stored instructions, data, tokens, etc. It will be appreciated that one or more buses may be used to interconnect the various components shown in FIG. 5.

It will be appreciated that additional components, not shown, may also be part of the system 500, and, in certain embodiments, fewer components than that shown in FIG. 5 may also be used in a data processing system 500.

The techniques shown in the figures can be implemented using code and data stored and executed on one or more electronic devices (e.g., a requester device, a responder device, and a server). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

In the claims and the preceding description, the terms “coupled” and “connected,” along with their derivatives, may be used. These terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a server for automatically generating a response to a request received from a first user, comprising:
receiving response configuration information from each of a first plurality of second users, wherein the received response configuration information includes for each of the first plurality of second users:
information indicating a type of request in which that second user is willing to fulfill including a set of one or more preferences for the type of request, and
information indicating a number of requests that second user can fulfill in a given period of time;
receiving, at the server, the request from the first user, wherein the request includes a plurality of parameters including:
a location where the request is to be fulfilled,
a request type, and
a set of one or more other parameters of the request type;
performing a first stage of matching that includes comparing the plurality of parameters of the request with the set of preferences received from the first plurality of second users to determine a number of the first plurality of second users whose set of preferences match;
determining, as a result of the first stage of matching, that the number of the first plurality of second users whose set of preferences match is below a threshold, and responsive to this determination, expanding the location where the request is to be fulfilled;
performing the first stage of matching that includes comparing the plurality of parameters of the request but with the expanded location with the set of preferences received from the first plurality of second users to determine an updated number of the first plurality of second users whose set of preferences match;
determining, as a result of the first stage of matching using the expanded location, that the updated number of the first plurality of second users whose set of preferences match meets the threshold;
performing a second stage of matching that includes computing a score for each of the updated number of the first plurality of second users;
determining a capacity to fulfill the request of each of the updated number of the first plurality of second users;
selecting a second plurality of second users based at least in part on the computed score and the determined capacity of each of the updated number of the first plurality of second users, wherein the second plurality of second users is less than the first plurality of second users; and
transmitting a result to the first user that includes information identifying the selected second plurality of second users.

2. The method of claim 1, wherein transmitting the result to the first user includes performing the following:
automatically generating a response to the request for each of the selected second plurality of second users; and
transmitting each generated response to the first user.

3. The method of claim 1, wherein transmitting the result to the first user includes automatically generating a customized web page that includes information on the selected second plurality of second users and transmitting the customized web page to the first user.

4. The method of claim 1, wherein computing the score includes computing a score that quantifies a likelihood of the first user selecting that second user to fulfill the request including using a logistic regression model that uses a set of one or more signals including one or more of the following:
reviews of that second user,
response time of that second user,
previous request fulfillment rate of that second user, and
distance between the first user and that second user.

5. The method of claim 1, wherein determining the capacity of the second user to fulfill the request further includes determining how many requests over the given time period the second user has fulfilled and how many requests the second user has agreed to fulfill or selected to fulfill.

6. The method of claim 1, wherein selecting the second plurality of second users based at least in part on the computed score and the determined capacity of each of the first plurality of second users includes performing the following:
computing a number of responses to send for the request, wherein computing the number of responses to send for the request includes performing the following:
for each of the first plurality of second users that match the location and category, performing the following:
determining an average number of requests that second user receives or has been determined to match in the category over a predetermined time period,
determining, based at least in part on the determined capacity of the second user to fulfill the request, a number of responses that can be sent on behalf of the second user over the predetermined time period, and
determining a maximum rate of sending a response over the predetermined time period based on the determined average number of requests that second user receives or has been determined to match in the category over the predetermined time period and the determined number of responses that can be sent on behalf of the second user over the predetermined time period;
determining a sum of the maximum rate of each of the first plurality of second users; and
wherein the computed number of responses to send for the request is based at least in part on the determined sum of the maximum rate of each of the first plurality of second users.

7. A non-transitory machine-readable storage medium that provides instructions that, when executed by a processor of a server, causes the processor to perform operations for automatically generating a response to a request received from a first user, the operations comprising:
receiving response configuration information from each of a first plurality of second users, wherein the received response configuration information includes for each of the first plurality of second users:
information indicating a type of request in which that second user is willing to fulfill including a set of one or more preferences for the type of request, and
information indicating a number of requests that second user can fulfill in a given period of time;
receiving, at the server, the request from the first user, wherein the request includes a plurality of parameters including:
a location where the request is to be fulfilled,
a request type, and
a set of one or more other parameters of the request type;
performing a first stage of matching that includes comparing the plurality of parameters of the request with the set of preferences received from the first plurality of second users to determine a number of the first plurality of second users whose set of preferences match;
determining, as a result of the first stage of matching, that the number of the first plurality of second users whose set of preferences match is below a threshold, and responsive to this determination, expanding the location where the request is to be fulfilled;
performing the first stage of matching that includes comparing the plurality of parameters of the request but with the expanded location with the set of preferences received from the first plurality of second users to determine an updated number of the first plurality of second users whose set of preferences match;
determining, as a result of the first stage of matching using the expanded location, that the updated number of the first plurality of second users whose set of preferences match meets the threshold;
performing a second stage of matching that includes computing a score for each of the updated number of the first plurality of second users;
determining a capacity to fulfill the request of each of the updated number of the first plurality of second users;
selecting a second plurality of second users based at least in part on the computed score and the determined capacity of each of the updated number of the first plurality of second users, wherein the second plurality of second users is less than the first plurality of second users; and
transmitting a result to the first user that includes information identifying the selected second plurality of second users.

8. The non-transitory machine-readable storage medium of claim 7, wherein transmitting the result to the first user includes:
automatically generating a response to the request for each of the selected second plurality of second users; and
transmitting each generated response to the first user.

9. The non-transitory machine-readable storage medium of claim 7, wherein transmitting the result to the first user includes automatically generating a customized web page that includes information on the selected second plurality of second users and transmitting the customized web page to the first user.

10. The non-transitory machine-readable storage medium of claim 7, wherein computing the score includes computing a score that quantifies a likelihood of the first user selecting that second user to fulfill the request including using a logistic regression model that uses a set of one or more signals including one or more of the following:
reviews of that second user,
response time of that second user,
previous request fulfillment rate of that second user, and
distance between the first user and that second user.

11. The non-transitory machine-readable storage medium of claim 7, wherein determining the capacity of the second user to fulfill the request further includes determining how many requests over the given time period the second user has fulfilled and how many requests the second user has agreed to fulfill or selected to fulfill.

12. The non-transitory machine-readable storage medium of claim 7, wherein selecting the second plurality of second users based at least in part on the computed score and the determined capacity of each of the first plurality of second users includes:
computing a number of responses to send for the request, wherein computing the number of responses to send for the request includes performing the following:
for each of the first plurality of second users that match the location and category, performing the following:
determining an average number of requests that second user receives or has been determined to match in the category over a predetermined time period,
determining, based at least in part on the determined capacity of the second user to fulfill the request, a number of responses that can be sent on behalf of the second user over the predetermined time period, and
determining a maximum rate of sending a response over the predetermined time period based on the determined average number of requests that second user receives or has been determined to match in the category over the predetermined time period and the determined number of responses that can be sent on behalf of the second user over the predetermined time period;
determining a sum of the maximum rate of each of the first plurality of second users; and
wherein the computed number of responses to send for the request is based at least in part on the determined sum of the maximum rate of each of the first plurality of second users.

13. An apparatus, comprising:
a processor; and
transitory machine-readable storage medium coupled with the processor that stores instructions that, when executed by the processor, cause said processor to perform operations for automatically generating a response to a request received from a first user, the operations including the following:
receive response configuration information from each of a first plurality of second users, wherein the received response configuration information includes for each of the first plurality of second users:
information indicating a type of request in which that second user is willing to fulfill including a set of one or more preferences for the type of request, and
information indicating a number of requests that second user can fulfill in a given period of time;
receive the request from the first user, wherein the request includes a plurality of parameters including:
a location where the request is to be fulfilled,
a request type, and
a set of one or more other parameters of the request type;
perform a first stage of matching that includes comparing the plurality of parameters of the request with the set of preferences received from the first plurality of second users to determine a number of the first plurality of second users whose set of preferences match;
determine, as a result of the first stage of matching, that the number of the first plurality of second users whose set of preferences match is below a threshold, and responsive to this determination, expanding the location where the request is to be fulfilled;
perform the first stage of matching that includes comparing the plurality of parameters of the request but with the expanded location with the set of preferences received from the first plurality of second users to determine an updated number of the first plurality of second users whose set of preferences match;
determine, as a result of the first stage of matching using the expanded location, that the updated number of the first plurality of second users whose set of preferences match meets the threshold;
perform a second stage of matching that includes computing a score for each of the updated number of the first plurality of second users;
determine a capacity to fulfill the request of each of the updated number of the first plurality of second users;
select a second plurality of second users based at least in part on the computed score and the determined capacity of each of the updated number of the first plurality of second users, wherein the second plurality of second users is less than the first plurality of second users; and
transmit a result to the first user that includes information identifying the selected second plurality of second users.

14. The apparatus of claim 13, wherein transmitting the result to the first user includes:
automatically generating a response to the request for each of the selected second plurality of second users; and
transmitting each generated response to the first user.

15. The apparatus of claim 13, wherein transmitting the result to the first user includes automatically generating a customized web page that includes information on the selected second plurality of second users and transmitting the customized web page to the first user.

16. The apparatus of claim 13, wherein computing the score includes computing a score that quantifies a likelihood of the first user selecting that second user to fulfill the request including using a logistic regression model that uses a set of one or more signals including one or more of the following:
reviews of that second user,
response time of that second user,
previous request fulfillment rate of that second user, and
distance between the first user and that second user.

17. The apparatus of claim 13, wherein determining the capacity of the second user to fulfill the request further includes determining how many requests over the given time period the second user has fulfilled and how many requests the second user has agreed to fulfill or selected to fulfill.

18. The apparatus of claim 13, wherein selecting the second plurality of second users based at least in part on the computed score and the determined capacity of each of the first plurality of second users includes:
computing a number of responses to send for the request, wherein computing the number of responses to send for the request includes performing the following:
for each of the first plurality of second users that match the location and category, performing the following:
determining an average number of requests that second user receives or has been determined to match in the category over a predetermined time period,
determining, based at least in part on the determined capacity of the second user to fulfill the request, a number of responses that can be sent on behalf of the second user over the predetermined time period, and
determining a maximum rate of sending a response over the predetermined time period based on the determined average number of requests that second user receives or has been determined to match in the category over the predetermined time period and the determined number of responses that can be sent on behalf of the second user over the predetermined time period;
determining a sum of the maximum rate of each of the first plurality of second users; and
wherein the computed number of responses to send for the request is based at least in part on the determined sum of the maximum rate of each of the first plurality of second users.
